(19) United States
(12) Patent Application Publication
(10) Pub. No.: US 2026/0127708 A1
(43) Pub. Date: May 7, 2026

(54) OPTICAL CONVOLUTION COMPUTING APPARATUS AND OPERATING METHOD OF OPTICAL CONVOLUTION COMPUTING APPARATUS

(71) Applicant: Electronics and Telecommunications Research Institute, Daejeon (KR)

(72) Inventors: Jin Hwa GENE, Daejeon (KR); Jong Moo SOHN, Daejeon (KR)

(73) Assignee: Electronics and Telecommunications Research Institute, Daejeon (KR)

(21) Appl. No.: 19/380,031

(22) Filed: Nov. 5, 2025

(30) Foreign Application Priority Data
Nov. 7, 2024 (KR) 10-2024-0156989
Oct. 1, 2025 (KR) 10-2025-0143408

(51) Int. Cl. G06T 5/10; G02B 5/04; G06T 5/20; G06V 10/141

(52) U.S. Cl. CPC G06T 5/10; G02B 5/04; G06T 5/20; G06V 10/141

(57) ABSTRACT

An optical convolution computing apparatus includes a first spatial light modulator that receives illumination light and first input data in a spatial domain and outputs modulated light, a transform device that receives kernel data in the spatial domain and generates kernel phase data and kernel amplitude data in a Fourier domain by performing a fast Fourier transform, a first optical transform device that generates first transformed light by performing an optical Fourier transform, a second spatial light modulator that outputs first element-wise produced light by performing a first element-wise product operation, a third spatial light modulator that outputs second element-wise produced light by performing a second element-wise product operation, a second optical transform device that generates second transformed light by performing an optical inverse Fourier transform, and an image sensor that generates output data based on the second transformed light.

### CROSS-REFERENCE TO RELATED APPLICATIONS

This application claims priority under 35 U.S.C. § 119 to Korean Patent Application No. 10-2024-0156989 filed on Nov. 7, 2024 and No. 10-2025-0143408 filed on Oct. 1, 2025, in the Korean Intellectual Property Office, the disclosures of which are incorporated by reference herein in their entireties.

### BACKGROUND

Embodiments of the present disclosure described herein relate to an optical convolution computing apparatus and an operating method of the optical convolution computing apparatus, and more particularly, relate to an optical convolution computing apparatus that performs a convolutional operation by using image data in a spatial domain and kernel data in a spatial domain having real values, and an operating method of the optical convolution computing apparatus.

An optical convolution operator is one of the optical computing apparatuses for implementing an optical convolutional artificial neural network. A conventional optical convolution operator has the form of an optical 4f-system based on Fourier optics, and is a device that performs convolutional operations by using a spatial domain image and a Fourier domain kernel.

The spatial domain image and the Fourier domain kernel are obtained by converting electronic signals to optical signals by using a device called a spatial light modulator. The electronic signals input to the spatial light modulator may only have positive values. Such a system is difficult to apply to a convolutional electronic computer-based convolutional artificial neural network structure, which mainly performs the convolution of a spatial domain kernel and a spatial domain insertion image over a range of real numbers.

### SUMMARY

Embodiments of the present disclosure provide an optical convolution computing apparatus that performs a convolutional operation by using image data in a spatial domain, and kernel data in a spatial domain having real values.

According to an embodiment, an optical convolution computing apparatus that performs a convolutional operation includes a first spatial light modulator that receives illumination light and first input data in a spatial domain and outputs modulated light by modulating the illumination light based on the first input data, a transform device that receives kernel data in the spatial domain and generates kernel phase data and kernel amplitude data in a Fourier domain by performing a fast Fourier transform on the kernel data, a first optical transform device that generates first transformed light by performing an optical Fourier transform on the modulated light, a second spatial light modulator that outputs first element-wise produced light by performing a first element-wise product operation on the first transformed light and the kernel amplitude data, a third spatial light modulator that outputs second element-wise produced light by performing a second element-wise product operation on the first element-wise produced light and the kernel phase data, a second optical transform device that generates second transformed light by performing an optical inverse Fourier transform on the second element-wise produced light, and an image sensor that generates output data based on the second transformed light.

In an embodiment, the first element-wise produced light includes Fourier plane information of the second spatial light modulator.

In an embodiment, each of a value of the kernel amplitude data and a value of the kernel phase data is positive.

In an embodiment, the value of the kernel amplitude data is included within a first normalization range, and the value of the kernel phase data is included within a second normalization range.

In an embodiment, the image sensor further receives local oscillator light. The image sensor generates the output data by using a homodyne detection method based on the second transformed light and the local oscillator light.

In an embodiment, a phase difference between the second transformed light and the local oscillator light is 0 or π.

In an embodiment, each of the illumination light and the local oscillator light is coherent light.

In an embodiment, a value of the first input data is a real number. The optical convolution computing apparatus performs the convolutional operation on each of a first positive part and a first negative part of the first input data.

In an embodiment, a result of the convolutional operation on the first input data is a sum of a result of the convolutional operation on the first positive part and a result of the convolutional operation on the first negative part.

In an embodiment, the result of the convolutional operation on the first input data is defined as second input data. The optical convolution computing apparatus performs the convolutional operation on each of a second positive part and a second negative part of the second input data.

In an embodiment, the apparatus further includes a fourth spatial light modulator that corrects a phase of the local oscillator light.

In an embodiment, the apparatus further includes a digital micromirror device that reflects the illumination light to the first spatial light modulator, and a wedge prism that controls a path of the modulated light.

According to an embodiment, a method for operating an optical convolution computing apparatus that performs a convolutional operation includes outputting, by a first spatial light modulator, modulated light by modulating illumination light based on first input data, generating, by a transform device, kernel phase data and kernel amplitude data in a Fourier domain by performing a fast Fourier transform on kernel data in a spatial domain, generating, by a first optical transform device, first transformed light by performing an optical Fourier transform on the modulated light, outputting, by a second spatial light modulator, first element-wise produced light by performing a first element-wise product operation on the first transformed light and the kernel amplitude data, outputting, by a third spatial light modulator, second element-wise produced light by performing a second element-wise product operation on the first element-wise produced light and the kernel phase data, generating, by a second optical transform device, second transformed light by performing an optical inverse Fourier transform on the second element-wise produced light, and generating, by an image sensor, output data based on the second transformed light.

In an embodiment, the first element-wise produced light includes Fourier plane information of the second spatial light modulator.

In an embodiment, each of a value of the kernel amplitude data and a value of the kernel phase data is positive.

In an embodiment, the value of the kernel amplitude data is included within a first normalization range, and the value of the kernel phase data is included within a second normalization range.

In an embodiment, the generating, by the image sensor, of the output data based on the second transformed light includes receiving, by the image sensor, local oscillator light, and generating, by the image sensor, the output data by using a homodyne detection method based on the second transformed light and the local oscillator light.

In an embodiment, a phase difference between the second transformed light and the local oscillator light is 0 or π.

In an embodiment, the method further includes correcting, a fourth spatial light modulator, a phase of the local oscillator light.

In an embodiment, the optical convolution computing apparatus includes a digital micromirror device that reflects the illumination light to the first spatial light modulator and a wedge prism that controls a path of the modulated light.

### BRIEF DESCRIPTION OF THE FIGURES

The above and other objects and features of the present disclosure will become apparent by describing in detail embodiments thereof with reference to the accompanying drawings.

FIG. 1 shows an example of an optical convolution computing apparatus.

FIG. 2 illustrates an example of an optical convolution computing apparatus, according to an embodiment of the present disclosure.

FIG. 3 shows an example of a data range capable of being input to an optical convolution computing apparatus, according to an embodiment of the present disclosure.

FIGS. 4A, 4B, and 4C show graphs illustrating sensing of the image sensor of FIG. 2.

FIG. 5 illustrates an example of a convolutional artificial neural network operation using an optical convolution computing apparatus, according to an embodiment of the present disclosure.

FIG. 6 shows an example of an optical convolution computing apparatus, according to an embodiment of the present disclosure.

FIG. 7 shows an example of an optical convolution computing apparatus, according to an embodiment of the present disclosure.

### DETAILED DESCRIPTION

Hereinafter, embodiments of the present disclosure will be described in detail and clearly to such an extent that an ordinary one in the art easily implements the present disclosure.

Hereinafter, embodiments of the present disclosure will be described in detail with reference to the accompanying drawings. The above and other aspects, features and advantages of the present disclosure will become apparent from embodiments to be described in detail in conjunction with the accompanying drawings. However, that the present disclosure is not limited to the following embodiments and may be implemented with various forms. Rather, embodiments introduced herein are provided to ensure that disclosed content is thorough and complete and to sufficiently convey the spirit of the present disclosure to those skilled in the art, and the present disclosure is defined only by the scope of claims. The same reference numerals denote the same elements throughout the specification.

The terms used in the specification are provided to describe the embodiments, not to limit the present disclosure. In the specification, the singular forms include plural forms unless particularly mentioned. The words ‘comprises’ and/or ‘comprising’ as used in the specification do not exclude the presence or addition of one or more other components, operations and/or elements in addition to the mentioned components, operations and/or elements. Moreover, because it is according to a preferred embodiment, the reference signs presented in the order of the description are not necessarily limited to that order.

Furthermore, embodiments described herein will be described with reference to cross-sectional and/or perspective views, which are ideal illustrations of the present disclosure. In the drawings, the thicknesses of films and regions are exaggerated to describe the technical features effectively. As such, variations from the shapes of the illustrations as a result, for example, of manufacturing techniques and/or tolerances, are to be expected. Thus, embodiments of the present disclosure are not limited to the specific shapes shown, but also include variations in shape produced by the manufacturing process.

In the detailed description, components described with reference to the terms “unit”, “module”, “block”, “˜er or ˜or”, etc. and function blocks illustrated in drawings will be implemented with software, hardware, or a combination thereof. For example, the software may be a machine code, firmware, an embedded code, and application software. For example, the hardware may include an electrical circuit, an electronic circuit, a processor, a computer, an integrated circuit, integrated circuit cores, a pressure sensor, an inertial sensor, a microelectromechanical system (MEMS), a passive element, or a combination thereof.

In the present disclosure, the expressions “A or B”, “at least one of A and B”, “at least one of A or B”, “A, B, or C”, “at least one of A, B, and C”, and “at least one of A, B, or C” may include any and all combinations of one or more of the associated listed items.

A convolutional artificial neural network is one of the artificial neural networks that exhibit high accuracy in inferring two-dimensional images, and are utilized in various fields such as autonomous driving and Internet of Things. As the role of artificial neural networks becomes more important in these fields, the structure of convolutional artificial neural networks is becoming more complex to improve inference accuracy and expand the range of recognition. Moreover, the amount of computation for convolutional artificial neural networks is increasing rapidly, and the development of electronic computers in terms of energy efficiency and computation speed is slow.

An optical computing apparatus is suitable for solving these issues because it has high energy efficiency and high parallel computing performance. An artificial neural network using the optical computing apparatus is referred to as an “optical artificial neural network”.

The convolutional artificial neural network is mainly composed of a convolutional layer placed at the front end, a fully connected layer placed at the back end, other computational layers such as an activation function, a pooling layer, etc. When the convolution layer is computed by using the optical convolution computing apparatus instead of an electronic computer, high energy efficiency and high parallel computing performance may be expected.

In an example, when a method of performing convolution by using image data in a spatial domain and kernel data in a Fourier domain having positive values, such as a method of an optical convolution computing apparatus, is compared to a method of performing a convolutional operation in a convolutional artificial neural network by using image data in a spatial domain and kernel data in a spatial domain having real values, there is a significant difference in computational results. This difference reduces the inference accuracy of the convolutional artificial neural network. Accordingly, it is necessary to develop an optical convolution computing apparatus capable of performing convolutional operations of image data in the spatial domain and kernel data in the spatial domain with real values to apply it to the convolutional artificial neural network.

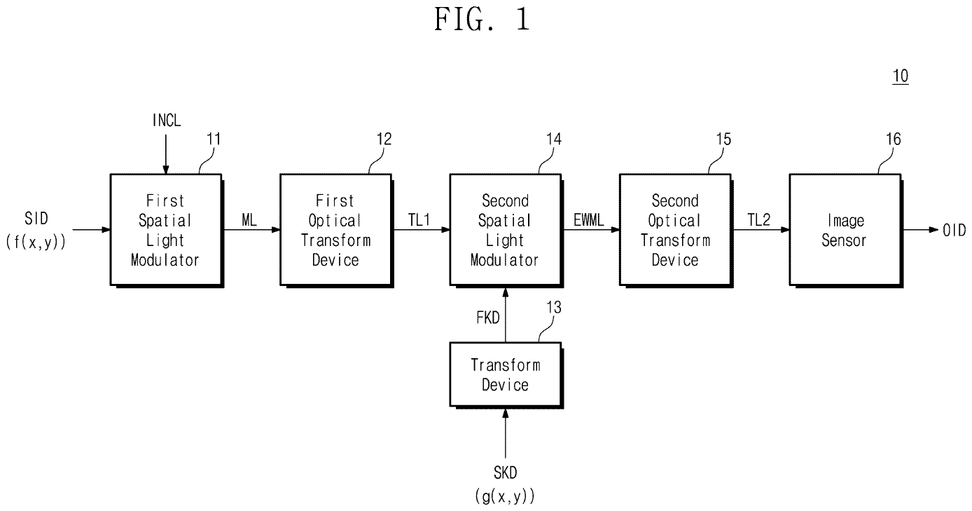

FIG. 1 shows an example of an optical convolution computing apparatus.

Referring to FIG. 1, an optical convolution computing apparatus 10 may include a first spatial light modulator 11, a first optical transform device 12, a transform device 13, a second spatial light modulator 14, a second optical transform device 15, and an image sensor 16.

The optical convolution computing apparatus 10 may perform a convolutional operation based on spatial domain image data SID and spatial domain kernel data SKD. The optical convolution computing apparatus 10 may be included and used in a convolutional neural network. The spatial domain image data SID may represent image data that is the target of processing and analysis of a convolutional neural network. The spatial domain kernel data SKD may correspond to at least one of kernels included in the convolutional neural network.

The optical convolution computing apparatus 10 may perform a convolutional operation based on Equation 1.

$$f ( x , y ) * g ( x , y ) = {𝒥}^{- 1} \{ F ( {x}^{′} , {y}^{′} ) \cdot G ( {x}^{′} , {y}^{′} ) \} \qquad [ Equation 1 ]$$

In Equation 1, ƒ̅(̅x̅,̅y̅)̅ may denote a spatial domain image function corresponding to the spatial domain image data SID; g̅(̅x̅,̅y̅)̅ may denote a spatial domain kernel function corresponding to the spatial domain kernel data SKD; F̅(̅x̅′̅,̅y̅′̅)̅ may denote a Fourier domain image function; and G̅(̅x̅′̅,̅y̅′̅)̅ may denote a Fourier domain kernel function.

The Fourier domain image function may represent a function that applies a Fourier transform to the spatial domain image function, and the Fourier domain kernel function may represent a function that applies the Fourier transform to the spatial domain kernel function. The Fourier domain kernel function may correspond to kernel data used in the convolutional neural network.

Referring to Equation 1, the convolutional operation on the spatial domain image function and the spatial domain kernel function may be equivalent to performing an element-wise product operation on the Fourier domain image function and the Fourier domain kernel function, and then performing an inverse Fourier transform on the result of the element-wise product operation.

The first spatial light modulator 11 may receive the spatial domain image data SID and illumination light INCL. In an embodiment, the illumination light INCL may be coherent light.

The first spatial light modulator 11 may output modulated light ML by modulating the illumination light INCL based on the spatial domain image data SID. For example, the first spatial light modulator 11 may modulate the amplitude or frequency of the illumination light INCL to generate the modulated light ML having a waveform corresponding to the spatial domain image data SID. The modulated light ML output from the first spatial light modulator 11 may represent light transmitted through the first spatial light modulator 11 or reflected from the first spatial light modulator 11.

The first optical transform device 12 may receive the modulated light ML. The first optical transform device 12 may include a single/multiple-lens system. The first optical transform device 12 may perform a Fourier transform on the modulated light ML by using the single/multiple-lens system and may output first transformed light TL1. In an embodiment, the first transformed light TL1 may correspond to the Fourier domain image function F̅(̅x̅′̅,̅y̅′̅)̅ of Equation 1.

The transform device 13 may receive the spatial domain kernel data SKD. The transform device 13 may perform a fast Fourier transform on the spatial domain kernel data SKD to generate Fourier domain kernel data FKD. The transform device 13 may output the Fourier domain kernel data FKD. In an embodiment, the transform device 13 may include a processor.

In an embodiment, the spatial domain kernel data SKD corresponds to the spatial domain kernel function g̅(̅x̅,̅y̅)̅ of Equation 1, and the Fourier domain kernel data FKD corresponds to the Fourier domain kernel function G̅(̅x̅′̅,̅y̅′̅)̅ of Equation 1.

The second spatial light modulator 14 may receive the first transformed light TL1 and the Fourier domain kernel data FKD. The second spatial light modulator 14 may modulate the first transformed light TL1 based on the Fourier domain kernel data FKD to output element-wise produced light EWML.

For example, the second spatial light modulator 14 may perform an element-wise product operation on the first transformed light TL1 and the Fourier domain kernel data FKD. As a result of performing the element-wise product operation, the second spatial light modulator 14 may output the element-wise produced light EWML. The element-wise produced light EWML may correspond to the result of the element-wise product operation between the Fourier domain functions in Equation 1. The element-wise produced light EWML may represent light transmitted through the second spatial light modulator 14 or reflected from the second spatial light modulator 14.

The second optical transform device 15 may receive the element-wise produced light EWML. The second optical transform device 15 may include a single/multiple-lens system. The second optical transform device 15 may perform an inverse Fourier transform on the element-wise produced light EWML by using the single/multiple-lens system to output second transformed light TL2. The second transformed light TL2 may correspond to the result of a convolutional operation between spatial domain functions in Equation 1.

The image sensor 16 may measure the second transformed light TL2 to generate output image data OID. In an embodiment, the image sensor 16 may be a camera.

In the case of the optical convolution computing apparatus 10, the convolutional operation may only be performed on the Fourier domain kernel data FKD with positive values, and thus Equation 1 may not be satisfied. Furthermore, the second transformed light TL2 includes amplitude data and phase data, and thus it has complex values. On the other hand, the image sensor 16 may only measure amplitude information. Accordingly, the inference accuracy of the optical convolution computing apparatus 10 may be low.

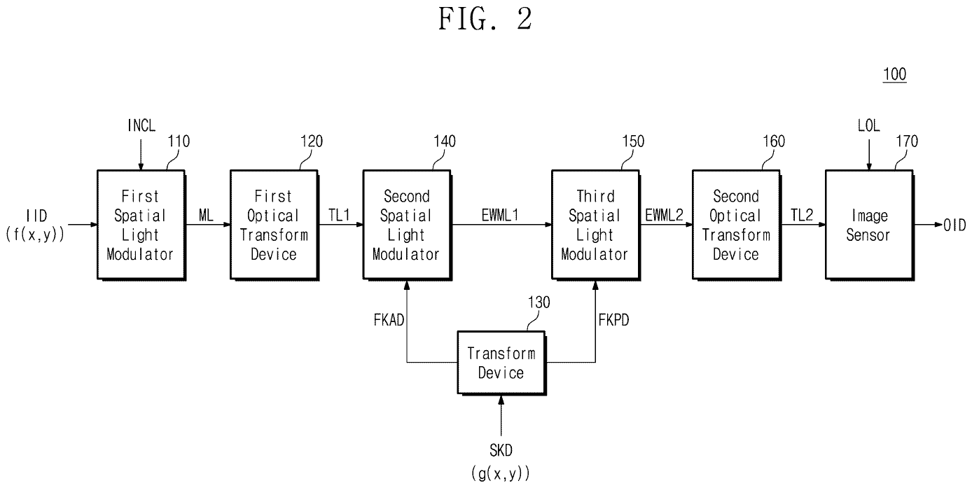

FIG. 2 illustrates an example of an optical convolution computing apparatus, according to an embodiment of the present disclosure.

Referring to FIG. 2, an optical convolution computing apparatus 100 may include a first spatial light modulator 110, a first optical transform device 120, a transform device 130, a second spatial light modulator 140, a third spatial light modulator 150, a second optical transform device 160, and an image sensor 170.

The first spatial light modulator 110 may receive the illumination light INCL and input image data IID in a spatial domain. In an embodiment, the illumination light INCL may be coherent light.

The first spatial light modulator 110 may output the modulated light ML by modulating the illumination light INCL based on the input image data IID. For example, the first spatial light modulator 110 may modulate the amplitude or frequency of the illumination light INCL to generate the modulated light ML having a waveform corresponding to the input image data IID.

The first optical transform device 120 may receive the modulated light ML. The first optical transform device 120 may include a single/multiple-lens system. The first optical transform device 120 may perform a Fourier transform on the modulated light ML by using the single/multiple-lens system and may output first transformed light TL1. In an embodiment, the first transformed light TL1 may correspond to the Fourier domain image function F̅(̅x̅′̅,̅y̅′̅)̅ of Equation 1.

The transform device 130 may receive the kernel data SKD in a spatial domain. The transform device 130 may perform a fast Fourier transform on the kernel data SKD to generate data in a Fourier domain. For example, the transform device 130 may perform a fast Fourier transform on the kernel data SKD to generate kernel amplitude data FKAD and kernel phase data FKPD in the Fourier domain. The transform device 130 may output the kernel amplitude data FKAD and the kernel phase data FKPD. In an embodiment, the transform device 130 may include a processor.

In an embodiment, the kernel amplitude data FKAD may correspond to an amplitude function |̅G̅(̅x̅′̅,̅y̅′̅)̅|̅ of the Fourier domain kernel function G̅(̅x̅′̅,̅y̅″̅)̅ of Equation 1. The kernel phase data FKPD may correspond to a phase function p̅h̅a̅s̅e̅(̅G̅(̅x̅′̅,̅y̅′̅)̅)̅ of the Fourier domain kernel function G̅(̅x̅′̅,̅y̅′̅)̅ of Equation 1.

The second spatial light modulator 140 may receive the first transformed light TL1 and the kernel amplitude data FKAD. The second spatial light modulator 140 may modulate the first transformed light TL1 based on the kernel amplitude data FKAD to output first element-wise produced light EWML1.

For example, the second spatial light modulator 140 may perform an element-wise product operation on the first transformed light TL1 and the kernel amplitude data FKAD. As a result of performing the element-wise product operation, the second spatial light modulator 140 may generate the first element-wise produced light EWML1. In an embodiment, the element-wise product operation may be a Hadamard product operation.

The first element-wise produced light EWML1 may include information about a Fourier domain plane of the second spatial light modulator 140. The first element-wise produced light EWML1 may be delivered to the third spatial light modulator 150 through a first optical system OS1. Accordingly, information about the Fourier domain plane of the second spatial light modulator 140 may be delivered to the third spatial light modulator 150.

In an embodiment, the first optical system OS1 may include an optical 4f system. When the optical 4f system is used, the Fourier domain of one plane may be delivered to the Fourier domain of another plane.

The third spatial light modulator 150 may receive the first element-wise produced light EWML1 and the kernel phase data FKPD. The third spatial light modulator 150 may modulate the first element-wise produced light EWML1 based on the kernel phase data FKPD to output second element-wise produced light EWML2.

For example, the third spatial light modulator 150 may perform an element-wise product operation on the first element-wise produced light EWML1 and the kernel phase data FKPD. As a result of performing the element-wise product operation, the third spatial light modulator 150 may output the second element-wise produced light EWML2. The second element-wise produced light EWML2 may correspond to the result of the element-wise product operation between the Fourier domain functions in Equation 1. In an embodiment, the element-wise product operation may be a Hadamard product operation.

The second optical transform device 160 may receive the second element-wise produced light EWML2. The second optical transform device 160 may include a single/multiple-lens system. The second optical transform device 160 may perform an inverse Fourier transform on the second element-wise produced light EWML2 by using the single/multiple-lens system to output the second transformed light TL2. The second transformed light TL2 may correspond to the result of a convolutional operation between spatial domain functions in Equation 1.

The image sensor 170 may receive the second transformed light TL2 and local oscillator light LOL. The image sensor 170 may measure the second transformed light TL2 based on the local oscillator light LOL. For example, the image sensor 170 may measure the second transformed light TL2 by using a homodyne detection method based on the local oscillator light LOL. In an embodiment, the local oscillator light LOL may be coherent light.

In an embodiment, the phase difference between the second transformed light TL2 and the local oscillator light LOL may have a constant value. For example, the phase difference between the second transformed light TL2 and the local oscillator light LOL may be 0 or π.

The image sensor 170 may sense the second transformed light TL2 by using a homodyne detection method based on the local oscillator light LOL and may generate the sensed light. The image sensor 170 may generate the output image data OID based on the sensed light. For example, the image sensor 170 may convert the sensed light into the output image data OID, which is electronic data.

In an embodiment, the optical convolution computing apparatus 100 may perform an element-wise product operation on the kernel phase data FKPD, and then may perform an element-wise product operation on the kernel amplitude data FKAD. For example, the second spatial light modulator 140 may perform an element-wise product operation on the kernel phase data FKPD, and the third spatial light modulator 150 may perform an element-wise product operation on the kernel amplitude data FKAD.

As described above, the optical convolution computing apparatus 100 may perform operations by converting input electronic data (e.g., the input image data IID) into light being optical data. In this case, the range of the input electronic data may be reset to correspond to the range of the optical data.

In an embodiment, the transform device 13 may include a processor.

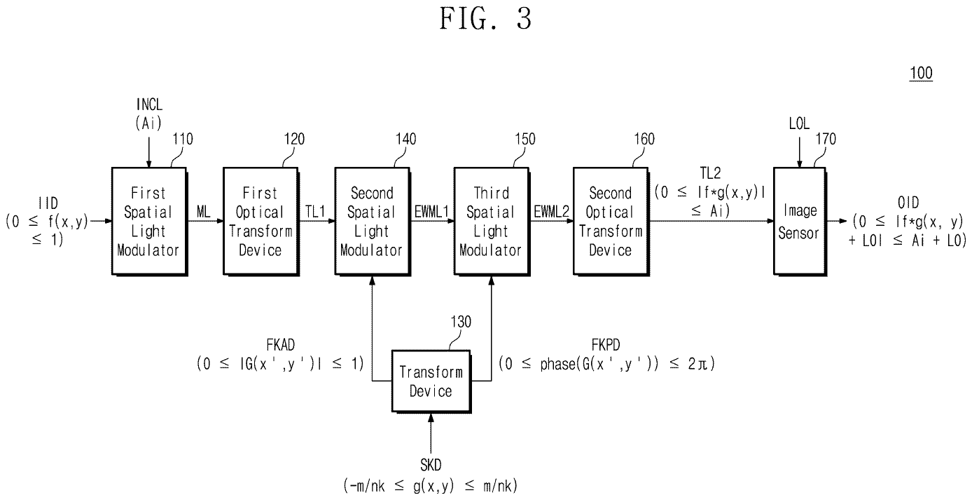

FIG. 3 shows an example of a data range capable of being input to an optical convolution computing apparatus, according to an embodiment of the present disclosure.

Referring to FIGS. 2 and 3, Ai may denote the amplitude of the illumination light INCL; L0 may denote the amplitude of the local oscillator light LOL; nk may denote the number of matrix elements in the kernel data SKD in a spatial domain; and, ‘m’ may denote the maximum value of the matrix elements in the kernel data SKD.

A data range input to a spatial light modulator (e.g., the first spatial light modulator 110, the second spatial light modulator 140, or the third spatial light modulator 150) may be normalized. For example, when the amplitude of light is modulated, the data range input to the spatial light modulator may be normalized to 0 to 1. When the phase of light is modulated, the data range input to the spatial light modulator may be normalized to 0 to 2π. Because the number of matrix elements in the kernel data SKD is nk and the maximum value of the matrix elements in the kernel data SKD is ‘m’, the amplitude value of the kernel amplitude data FKAD may be “nk*m”. Accordingly, when the maximum value of the data input to the spatial light modulator for amplitude modulation is satisfied as 1, the kernel data SKD needs to be divided by “nk*m” before the Fourier transform is performed on the kernel data SKD, or the kernel amplitude data FKAD needs to be divided by “nk*m” after the Fourier transform is performed on the kernel data SKD.

In the meantime, the sensitivity of the image sensor 170 may be corrected to sense data, which is actually input to the image sensor 170 and which ranges from L0 to “Ai+Lo”, as data ranging from −1 to 1.

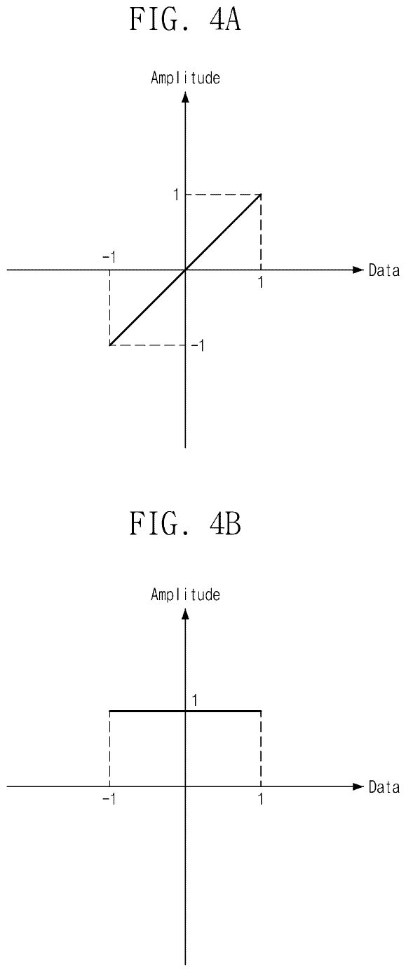

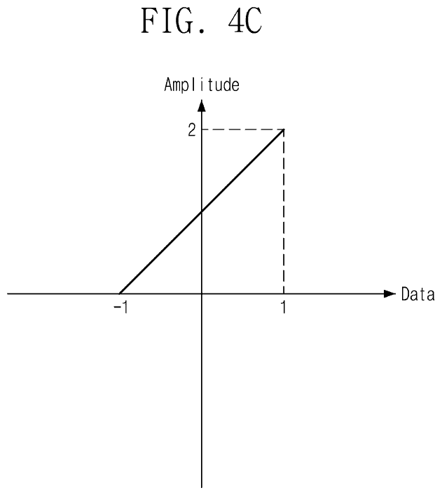

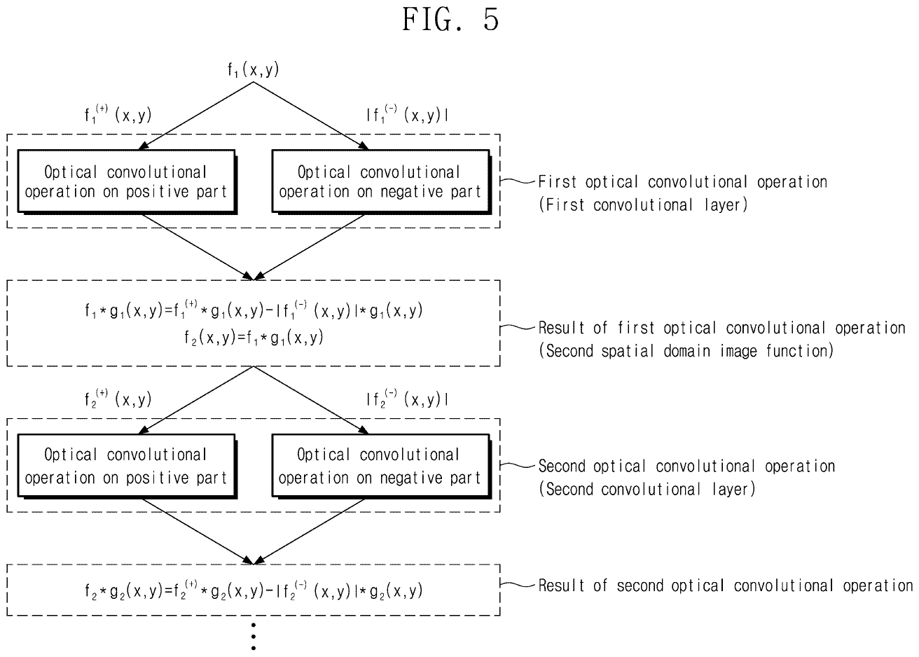

FIGS. 4A to 4C show graphs illustrating sensing of the image sensor of FIG. 2. FIG. 4A may relate to the second transformed light TL2 of FIG. 2, which corresponds to the result of the convolutional operation; FIG. 4B may relate to the local oscillator light LOL of FIG. 2; and FIG. 4C may relate to light sensed by the image sensor 170 of FIG. 2.

In FIGS. 4A to 4C, a horizontal axis may represent data, and a vertical axis may represent amplitude.

Referring to FIGS. 2 and 4A to 4C, the image sensor 170 may convert optical data having real values into electronic data by using a homodyne detection method.

The phase difference between the second transformed light TL2 and the local oscillator light LOL may be 0. When the amplitude of the second transformed light TL2 has a value between −1 and 1, and the amplitude of the local oscillator light LOL is 1, the amplitude of the light sensed by the image sensor 170 may have a value between 0 and 2. In other words, the image sensor 170 may sense all the second transformed light TL2 having a value between −1 and 1, as positive values, thereby converting optical data having real values into electronic data.

FIG. 5 illustrates an example of a convolutional artificial neural network operation using an optical convolution computing apparatus, according to an embodiment of the present disclosure.

Referring to FIGS. 2 and 5, the optical convolution computing apparatus 100 may perform operations on a convolutional artificial neural network including a plurality of convolution layers by separating positive and negative parts of input data and performing convolutional operations.

The optical convolution computing apparatus 100 may perform a convolutional operation based on Equation 2.

$$f ( x , y ) * g ( x , y ) = ( {f}^{( + )} ( x , y ) - \vert {f}^{( - )} ( x , y ) \vert ) * g ( x , y ) = {f}^{( + )} ( x , y ) * g ( x , y ) - \vert {f}^{( - )} ( x , y ) \vert * g ( x , y ) \qquad [ Equation 2 ]$$

In Equation 2, ƒ̅(̅x̅,̅y̅)̅ may denote a spatial domain image function; g̅(̅x̅,̅y̅)̅ may denote a spatial domain kernel function; ƒ̅⁽̅⁺̅⁾̅(̅x̅,̅y̅)̅ may denote a positive part of a spatial domain image function; and |̅ƒ̅⁽̅⁻̅⁾̅(̅x̅,̅y̅)̅|̅ may denote a negative part of a spatial domain image function.

As shown in Equation 2, data having real values may be input to the optical convolution computing apparatus 100. Furthermore, the optical convolution computing apparatus 100 may perform convolutional operations on the data having real values.

Returning to FIG. 5, a first spatial domain image function ƒ̅₁̅(̅x̅,̅y̅)̅ may be separated into the first positive part

$$\overline{{f}_{1}^{( + )} ( x , y )}$$

and the first negative part

$$\overline{\vert {f}_{1}^{( - )} ( x , y ) \vert} .$$

The optical convolution computing apparatus 100 may perform the first optical convolutional operation on each of the first positive part

$$\overline{{f}_{1}^{( + )} ( x , y )} \text{?}$$

$$\text{?} \text{indicates text missing or illegible when filed}$$

and the first negative part

$$\overline{\vert {f}_{1}^{( - )} ( x , y ) \vert}$$

in a first convolution layer. The result ƒ̅₁̅*̅g̅₁̅(̅x̅,̅y̅)̅ of the first convolutional operation on the first spatial domain image function ƒ̅₁̅(̅x̅,̅y̅)̅ may be expressed as the sum of the result

$$\overline{{f}_{1}^{( + )} ⋆ {g}_{1} ( x , y )}$$

of the first convolutional operation on the first positive part

$$\overline{{f}_{1}^{( + )} ( x , y )}$$

and the result

$$\overline{\vert f \text{?} ( x , y ) \vert ⋆ {g}_{1} ( x , y )}$$

$$\text{?} \text{indicates text missing or illegible when filed}$$

of the first convolutional operation on the first negative part

$$\overline{\vert {f}_{1}^{( - )} ( x , y ) \vert} .$$

The result ƒ̅₁̅*̅g̅₁̅(̅x̅,̅y̅)̅ of the first convolutional operation on the first spatial domain image function ƒ̅₁̅(̅x̅,̅y̅)̅ may be defined as a second spatial domain image function ƒ̅₂̅(̅x̅,̅y̅)̅.

The second spatial domain image function ƒ̅₂̅(̅x̅,̅y̅)̅ may be separated into a second positive part

$$\overline{{f}_{2}^{( + )} ( x , y )}$$

and a second negative part

$$\overline{\vert {f}_{2}^{( - )} ( x , y ) \vert} .$$

The optical convolution computing apparatus 100 may perform a second optical convolutional operation on each of the second positive part

$$\overline{{f}_{2}^{( + )} ( x , y )}$$

and the second negative part

$$\overline{\vert {f}_{2}^{( - )} ( x , y ) \vert}$$

in a second convolution layer. The result ƒ̅₂̅*̅g̅₂̅(̅x̅,̅y̅)̅ of the second convolutional operation on the second spatial domain image function ƒ̅₂̅(̅x̅,̅y̅)̅ may be expressed as the sum of the result

$$\overline{{f}_{2}^{( + )} ⋆ {g}_{2} ( x , y )}$$

of the second convolutional operation on the second positive part

$$\overline{{f}_{2}^{( + )} ( x , y )} ,$$

and the result

$$\overline{\vert f \text{?} \vert ⋆ {g}_{2} ( x , y )}$$

$$\text{?} \text{indicates text missing or illegible when filed}$$

of the second convolutional operation on the second negative part

$$\overline{\vert {f}_{2}^{( - )} ( x , y ) \vert} .$$

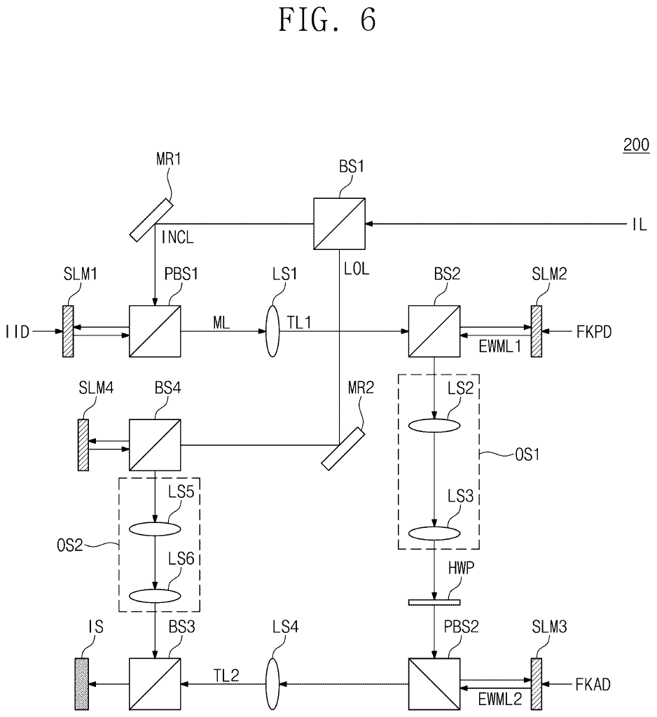

FIG. 6 shows an example of an optical convolution computing apparatus, according to an embodiment of the present disclosure. In FIG. 6, polarizing beam splitters PBS1 and PBS2 and beam splitters BS1 to BS4 may adjust an optical path or may select polarization-modulated light. In FIG. 6, spatial light modulators SLM1 to SLM4 may be liquid crystal spatial light modulators LC-SLM.

Referring to FIG. 6, input light IL may be split into the illumination light INCL and the local oscillator light LOL by the first beam splitter BS1. The input light may be a laser that is coherent light.

The illumination light INCL may be reflected by a first mirror MR1 and then may be directed to the first spatial light modulator SLM1 by the first polarizing beam splitter PBS1. The first spatial light modulator SLM1 may output the modulated light ML by modulating the illumination light INCL based on the input image data IID in a spatial domain.

The modulated light ML may then pass through the first polarizing beam splitter PBS1 and then may be directed to the first lens LS1. The first lens LS1 may output the first transformed light TL1 by performing a Fourier transform on the modulated light ML.

The first transformed light TL1 may pass through the second beam splitter BS2 and then may be directed to the second spatial light modulator SLM2. The second spatial light modulator SLM2 may output the first element-wise produced light EWML1 by performing an element-wise product operation between the kernel phase data FKPD in the Fourier domain and the first transformed light TL1.

The first element-wise produced light EWML1 may be reflected by the second beam splitter BS2 and then may sequentially pass through the first optical system OS1, which includes a second lens LS2 and a third lens LS3, and a half-wave plate HWP. Information about the Fourier domain plane of the second spatial light modulator SLM2, which is included in the first element-wise produced light EWML1, may be delivered to the third spatial light modulator SLM3 via the first optical system OS1. In an embodiment, the half-wave plate HWP may rotate the polarization direction of the first element-wise produced light EWML1.

After passing through the half-wave plate HWP, the first element-wise produced light EWML1 may be directed to the third spatial light modulator SLM3 by the second polarizing beam splitter PBS2. The third spatial light modulator SLM3 may output the second element-wise produced light EWML2 by performing an element-wise product operation between the kernel amplitude data FKAD in the Fourier domain and the first element-wise produced light EWML1.

The second element-wise produced light EWML2 may pass through the second polarizing beam splitter PBS2 and then may be directed to a fourth lens LS4. The fourth lens LS4 may output the second transformed light TL2 by performing an inverse Fourier transform on the second element-wise produced light EWML2. The second transformed light TL2 may pass through the third beam splitter BS3 and then may be directed to an image sensor IS.

In the meantime, the local oscillator light LOL, which is split by the first beam splitter BS1, may be reflected by a second mirror MR2 and then may be directed to the fourth spatial light modulator SLM4 through the fourth beam splitter BS4. The fourth spatial light modulator SLM4 may match phases of the second transformed light TL2 and the local oscillator light LOL with each other by correcting the phase of the local oscillator light LOL. The phase-corrected local oscillator light LOL may be reflected by the fourth beam splitter BS4 and may pass through a second optical system OS2 including a fifth lens LS5 and a sixth lens LS6. After passing through the second optical system OS2, the local oscillator light LOL may be reflected by the third beam splitter BP3 and then may be directed to the image sensor IS. In an embodiment, the second optical system OS2 may include an optical 4f system.

In an embodiment, when the phase difference between the second transformed light TL2 and the local oscillator light LOL is stable (e.g., when the phase difference between the second transformed light TL2 and the local oscillator light LOL is less than or equal to a threshold value), the fourth spatial light modulator SLM4 may be omitted.

In an embodiment, unlike in FIG. 6, the operations of the second spatial light modulator SLM2 and the third spatial light modulator SLM3 may be switched into each other. For example, the second spatial light modulator SLM2 may perform an element-wise product operation on the kernel amplitude data FKAD, and the third spatial light modulator SLM3 may perform an element-wise product operation on the kernel phase data FKPD.

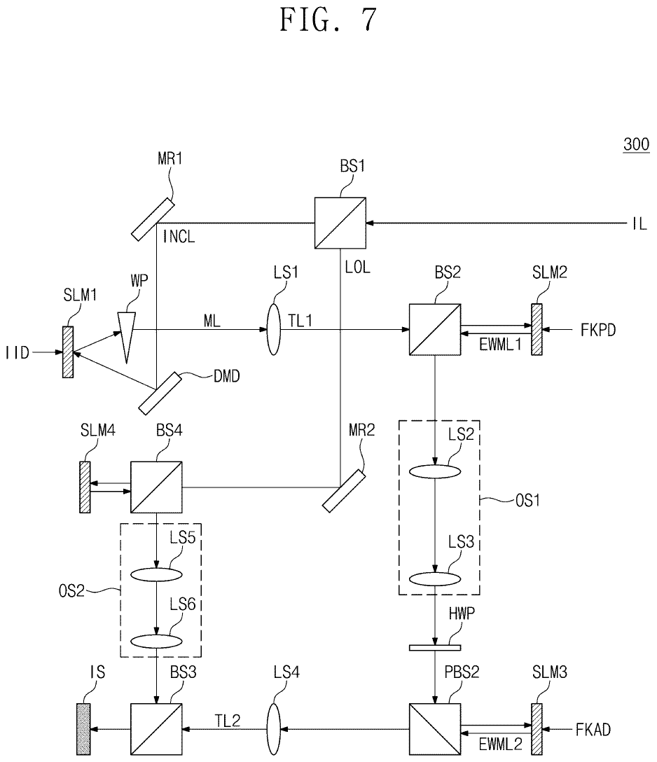

FIG. 7 shows an example of an optical convolution computing apparatus, according to an embodiment of the present disclosure. In FIG. 7, an optical convolution computing apparatus 300 may be the same as an optical convolution computing apparatus 200 of FIG. 6, except that it includes a digital micromirror device DMD and a wedge prism WD instead of the first polarizing beam splitter PBS1 of FIG. 6. Accordingly, for convenience of description, redundant descriptions are omitted.

The illumination light INCL may be reflected by the digital micromirror device DMD and may be directed to the first spatial light modulator SLM1. The modulated light ML output from the first spatial light modulator SLM1 may be directed to the first lens LS1 via the wedge prism WP. The first lens LS1 may output the first transformed light TL1 by performing a Fourier transform on the modulated light ML.

The illumination light INCL may be incident on the digital micromirror device DMD at a constant angle of incidence and may be reflected by the digital micromirror device DMD at a constant angle of reflection.

The wedge prism WP may control the optical path of the modulated light ML, thereby matching the modulated light ML with the Fourier domain plane of the second spatial light modulator SLM2. In an embodiment, when the reflection angle of light reflected from the digital micromirror device DMD is perpendicular to the plane of the digital micromirror device DMD, the wedge prism WP may be omitted.

A convolutional artificial neural network may perform a convolutional operation on a piece of kernel data and pieces of input image data IID. Accordingly, when an LC-SLM is used, the light modulation speed may be slow.

On the other hand, when the digital micromirror device DMD is partially used, the digital micromirror device DMD may modulate the pieces of input image data IID by using its high modulation speed while the LC-SLM modulates the piece of kernel data. Therefore, the computational speed of the convolutional artificial neural network may be improved.

In the above embodiments, components according to the present disclosure are described by using the terms “first”, “second”, “third”, etc. However, the terms “first”, “second”, “third”, etc. may be used to distinguish components from each other and do not limit the present disclosure. For example, the terms “first”, “second”, “third”, etc. do not involve an order or a numerical meaning of any form.

The above-mentioned description refers to embodiments for implementing the scope of the present disclosure. Embodiments in which a design is changed simply or which are easily changed may be included in the scope of the present disclosure as well as an embodiment described above. In addition, technologies that are easily changed and implemented by using the above-mentioned embodiments may be also included in the scope of the present disclosure.

According to an embodiment of the present disclosure, an optical convolution computing apparatus may achieve high energy efficiency and high parallel computing performance.

According to an embodiment of the present disclosure, an optical convolutional computing apparatus may implement similar or the same inference accuracy as a convolutional artificial neural network using an electronic computer.

According to an embodiment of the present disclosure, an optical convolution computing apparatus may use the structure of a conventional convolutional artificial neural network without modification.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An optical convolution computing apparatus that performs a convolutional operation, the apparatus comprising:
a first spatial light modulator configured to receive illumination light and first input data in a spatial domain and to output modulated light by modulating the illumination light based on the first input data;
a transform device configured to receive kernel data in the spatial domain and to generate kernel phase data and kernel amplitude data in a Fourier domain by performing a fast Fourier transform on the kernel data;
a first optical transform device configured to generate first transformed light by performing an optical Fourier transform on the modulated light;
a second spatial light modulator configured to output first element-wise produced light by performing a first element-wise product operation on the first transformed light and the kernel amplitude data;
a third spatial light modulator configured to output second element-wise produced light by performing a second element-wise product operation on the first element-wise produced light and the kernel phase data;
a second optical transform device configured to generate second transformed light by performing an optical inverse Fourier transform on the second element-wise produced light; and
an image sensor configured to generate output data based on the second transformed light.

2. The apparatus of claim 1, wherein the first element-wise produced light includes Fourier plane information of the second spatial light modulator.

3. The apparatus of claim 2, wherein each of a value of the kernel amplitude data and a value of the kernel phase data is positive.

4. The apparatus of claim 3, wherein the value of the kernel amplitude data is included within a first normalization range, and
wherein the value of the kernel phase data is included within a second normalization range.

5. The apparatus of claim 4, wherein the image sensor further receives local oscillator light, and
wherein the image sensor generates the output data by using a homodyne detection method based on the second transformed light and the local oscillator light.

6. The apparatus of claim 5, wherein a phase difference between the second transformed light and the local oscillator light is 0 or π.

7. The apparatus of claim 6, wherein each of the illumination light and the local oscillator light is coherent light.

8. The apparatus of claim 7, wherein a value of the first input data is a real number, and
wherein the optical convolution computing apparatus performs the convolutional operation on each of a first positive part and a first negative part of the first input data.

9. The apparatus of claim 8, wherein a result of the convolutional operation on the first input data is a sum of a result of the convolutional operation on the first positive part and a result of the convolutional operation on the first negative part.

10. The apparatus of claim 9, wherein the result of the convolutional operation on the first input data is defined as second input data, and
wherein the optical convolution computing apparatus performs the convolutional operation on each of a second positive part and a second negative part of the second input data.

11. The apparatus of claim 7, further comprising:
a fourth spatial light modulator configured to correct a phase of the local oscillator light.

12. The apparatus of claim 11, further comprising:
a digital micromirror device configured to reflect the illumination light to the first spatial light modulator; and
a wedge prism configured to control a path of the modulated light.

13. A method for operating an optical convolution computing apparatus that performs a convolutional operation, the method comprising:
outputting, by a first spatial light modulator, modulated light by modulating illumination light based on first input data;
generating, by a transform device, kernel phase data and kernel amplitude data in a Fourier domain by performing a fast Fourier transform on kernel data in a spatial domain;
generating, by a first optical transform device, first transformed light by performing an optical Fourier transform on the modulated light;
outputting, by a second spatial light modulator, first element-wise produced light by performing a first element-wise product operation on the first transformed light and the kernel amplitude data;
outputting, by a third spatial light modulator, second element-wise produced light by performing a second element-wise product operation on the first element-wise produced light and the kernel phase data;
generating, by a second optical transform device, second transformed light by performing an optical inverse Fourier transform on the second element-wise produced light; and
generating, by an image sensor, output data based on the second transformed light.

14. The method of claim 13, wherein the first element-wise produced light includes Fourier plane information of the second spatial light modulator.

15. The method of claim 14, wherein each of a value of the kernel amplitude data and a value of the kernel phase data is positive.

16. The method of claim 15, wherein the value of the kernel amplitude data is included within a first normalization range, and
wherein the value of the kernel phase data is included within a second normalization range.

17. The method of claim 16, wherein the generating, by the image sensor, of the output data based on the second transformed light includes:
receiving, by the image sensor, local oscillator light; and
generating, by the image sensor, the output data by using a homodyne detection method based on the second transformed light and the local oscillator light.

18. The method of claim 17, wherein a phase difference between the second transformed light and the local oscillator light is 0 or π.

19. The method of claim 18, further comprising:
correcting, a fourth spatial light modulator, a phase of the local oscillator light.

20. The method of claim 19, wherein the optical convolution computing apparatus includes:
a digital micromirror device configured to reflect the illumination light to the first spatial light modulator, and
a wedge prism configured to control a path of the modulated light.
